(19) United States
(12) Patent Application Publication
(10) Pub. No.: US 2008/0210797 A1
(43) Pub. Date: Sep. 4, 2008

(54) Tubular Mill

(76) Inventors: Alexander Hagedorn, Pulheim (DE); Norbert Aufsfeld, Pulheim (DE)

Correspondence Address: GREER, BURNS & CRAIN, 300 S WACKER DR, 25TH FLOOR, CHICAGO, IL, 60606, US

(21) Appl. No.: 11/912,523

(22) PCT Filed: Apr. 20, 2006
(86) PCT No.: PCT/EP2006/003601

§ 371 Date: Oct. 25, 2007

(30) Foreign Application Priority Data
Apr. 27, 2005 (DE) 10 2006 019 473.7
Mar. 24, 2006 (DE) 10 2006 013 569.5

(51) Int. Cl. B02C 17/04; B02C 17/18

(52) U.S. Cl. 241/294

(57) ABSTRACT

In order to provide a tubular mill which is lightweight and easy and inexpensive to manufacture, the partial lengths of the tubular mill shell each are screwed together from segments which are distributed around the circumference and are made of thin-walled sheet-metal material, wherein rigid flanges are integrally formed onto the abutting sides of adjacent segments, in particular by folding the edges of the sheet-metal, and the flanges, which come to be positioned in the longitudinal direction of the mill tube, of adjacent segments are screwed to one another, and rigid flanges are to be integrally formed onto the two other sides, positioned opposite one another, of the segments, likewise advantageously by folding the edges of the sheet-metal, and the flanges, each joined to form a flange ring, of adjacent partial lengths are clamped to one another by means of clamping elements.

The invention relates to a tubular mill having a mill tube which is mounted so as to be rotatable about the longitudinal axis and whose shell is composed of a plurality of partial lengths.

Tubular mills serve to comminute or mill material to be milled, said material being transported in the rotating mill tube from the input end for the material to be milled to the discharge end for the milled material, generally using mill air or a drying gas, and in the process is usually milled using milling bodies such as, for example, steel balls, which are located in the mill tube so that instead of tubular mills, terms such as ball mills, air stream mills etc. are used. In the case of tubular mills which are suitable for large throughput rates, the mill tube has a correspondingly large length and a large diameter, and it is therefore subject to the risk of sagging and of other deformations.

In order to reduce this risk, until now the mill tube in tubular mills was previously welded together from a plurality of thick-walled cylindrical partial lengths, which made the entire tubular mill very heavy. This was the case both when the mill tube is rotatably mounted on its circumference, specifically supported on sliding bearing shells which are arranged distributed around the underside of the mill tube shell, and particularly when the mill tube is mounted at both ends in what are referred to as neck collar journal bearings because with this solution the mill tube has to be made particularly rigid and therefore embodied with thick walls. In addition, the deformation of thick-walled sheet steel to form cylindrical tubular lengths or partial lengths constitutes a costly fabrication process which has an adverse effect on the cost of such tubular mills.

The invention is based on the object of providing a tubular mill which is easy and inexpensive to manufacture.

This object is achieved according to the invention with a tubular mill having the features of claim 1. Advantageous developments of the invention are specified in the subclaims.

Firstly, a characteristic of the tubular mill according to the invention is that the mill tube has a comparatively extremely thin-walled sheet-metal shell compared to previously known tubular mills, wherein a thickness of the sheet-metal wall of, for example, 20 mm is, as explained in more detail further below, considered to be thin-walled. This sheet-metal shell is not welded together in one piece, and not welded together from cylindrical partial lengths either, but rather is screwed together from prefabricated sheet-metal segments and partial lengths.

According to one particular feature of the invention, all the partial lengths are screwed together from segments which are distributed around the circumference and are made of the thin-walled sheet-metal material, which is possible by virtue of the fact that rigid flanges are integrally formed onto the abutting sides of adjacent segments of, in each case, one partial length, for example by welding on or, more easily, by bending edges of the sheet-metal, as a result of which the flanges, which come to be positioned in the longitudinal direction of the mill tube, of adjacent sheet-metal segments are screwed to one another to form a partial length. These flange connections which come to be positioned in the longitudinal direction of the mill tube make the thin-walled sheet-metal shell sufficiently flexurally strong.

According to the invention, rigid flanges are also in turn integrally formed onto the two other sides, positioned opposite one another, of the sheet-metal segments, for example by welding on or, more simply, by bending the edges of the sheet-metal, and the flanges, each fitted together to form a flange ring, of adjacent partial lengths are then clamped to one another by means of clamping elements such as flange screws to form the complete, thin-walled, but still deformation-resistant sheet-metal shell.

Taking initially flat, rectangular sheet-metal segments as a basis, the side flanges which are necessary for assembly can therefore be manufactured by folding in each case all four segment edges, in which case folding is to be understood as meaning bending over of the edges of the sheet metal through approximately 90°.

The prefabricated sheet-metal segments can, according to a further feature of the invention, have at least one slight bend which extends in the longitudinal direction of the mill tube and is also manufactured by means of a bending process, as a result of which bend the segments are given a somewhat gable-roof-shaped configuration, as a result of which the sheet-metal segments which are positioned one against the other and are distributed around the circumference of a partial length approximate to a circular shape when viewed from the front end, and as a result of which the rigidity of the sheet-metal segments which are per se thin-walled is also increased. In addition, before the prefabricated sheet-metal segments are processed such as by being bent etc., they can also be provided with through bores for later attachment of armored elements to the inner wall of the screwed-together tubular mill shell and to the flange hole bores.

The advantages of the tubular mill shell according to the invention and its manufacture are significant. In contrast to complete mill tubes or partial lengths of tubes with a large diameter, the sheet-metal segments are easy to transport, specifically also with normal trucks. The sheet-metal segments can be replaced on an individual basis. In addition, one or more of the sheet-metal segments can serve at the same time as a manhole for the tubular mill at a desired location on the tube shell.

The thinness of the walls of the tubular mill shell according to the invention or of the partial lengths and sheet-metal segments is explained by means of the following numerical example:

In the previously known tubular mills, the wall thickness of the mill tube was, as a rule of thumb, approximately 1/100 of the diameter of the mill tube, that is to say as an example a mill tube with a diameter of 4,200 mm would have a wall thickness of the mill tube of approximately 42 mm. In contrast, the tubular mill according to the invention has a wall thickness of the mill tube which is less than half of this, for example 20 mm, i.e. a mill tube wall thickness< 1/200 of the diameter of the mill tube.

According to a further feature of the invention, the front side flanges of the sheet-metal segments can have thicker walls than the thin-walled sheet-metal segments if said flanges are not manufactured by folding but rather by welding. In order to increase further the rigidity of the fitted-together tubular mill shell, the flange rings of adjacent partial lengths are screwed to one another and/or also clamped to one another in such a way that, when viewed in the longitudinal direction of the mill tube, the end flange of the one partial length is clamped in each case to the starting flange of the next but one partial length by means of tensioning or clamping elements which are distributed around the outer circumference of the next partial length. In this context, the tensioning or clamping elements which are distributed around the outer circumference of the mill tube shell can be tie rods and/or preferably cables by means of which the thin walled partial lengths can also be reciprocally clamped so that they can take up the acting forces and loads. These additional tensioning elements or cables can be arranged parallel and/or also diagonal to the longitudinal axis of the tube.

On one of the locations on the flange ring, a crown gear for the rotary drive for the tubular mill can be attached. In addition, the running rings of the tubular mill can also be mounted on the rigid flange rings so that the mill tube then does not have to be mounted at both ends in neck collar journal bearings but rather is mounted on the circumference of the tube shell. Further stiffening of the thin-walled and lightweight mill tube according to the invention can also be achieved by armoring which is clamped to its inner wall and interacts with the milling bodies, in particular steel balls of the tubular mill.

The invention and its further features and advantages are explained in more detail below by means of exemplary embodiments which are illustrated schematically in the drawing, in which:

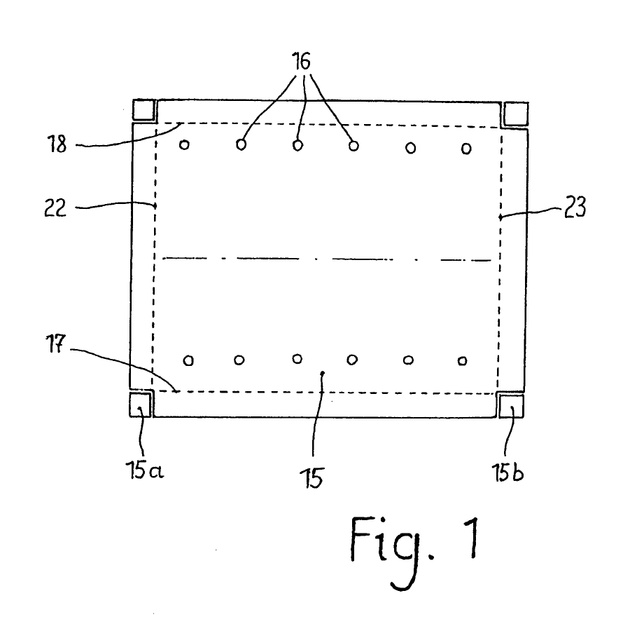

FIG. 1 is a plan view of a rectangular, flat sheet steel segment with a wall thickness of, for example, 20 mm,

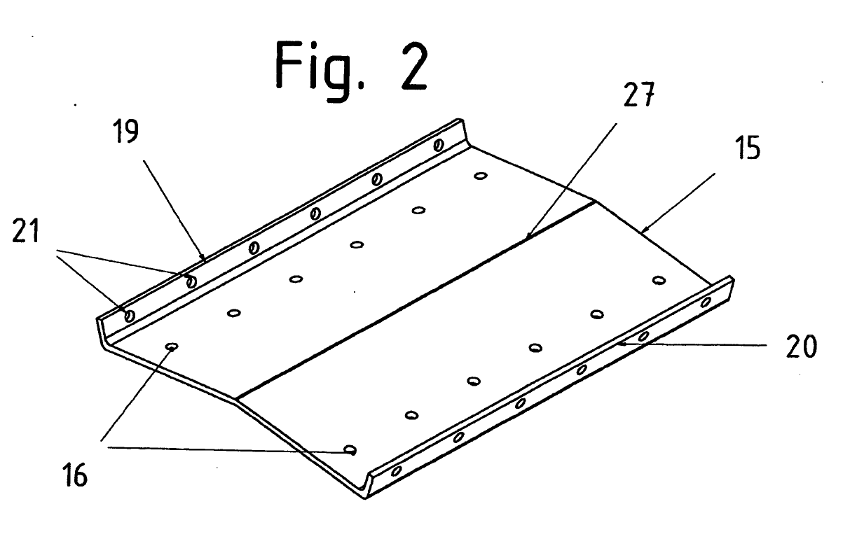

FIG. 2 is a perspective view of the sheet-metal segment in FIG. 1 during its preparation for the mounting of a tubular mill shell,

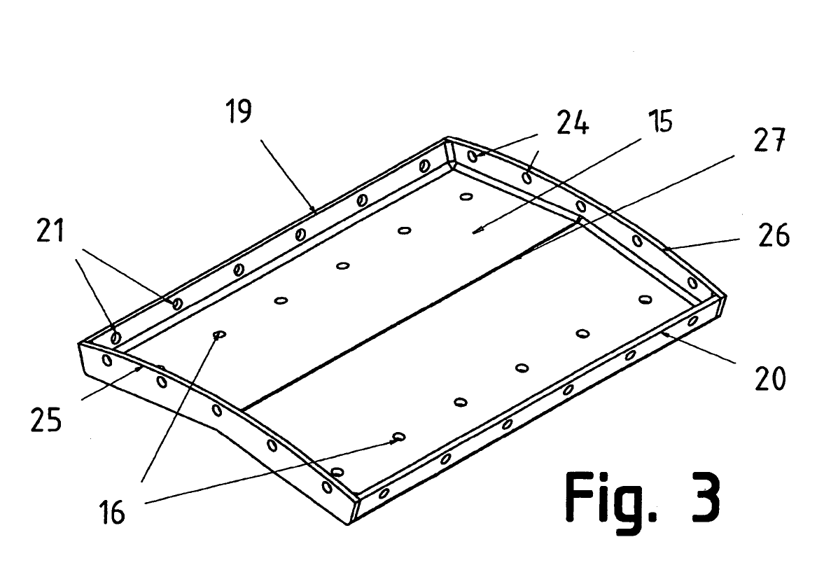

FIG. 3 is a perspective view of the completely prefabricated, finished segment in FIG. 2,

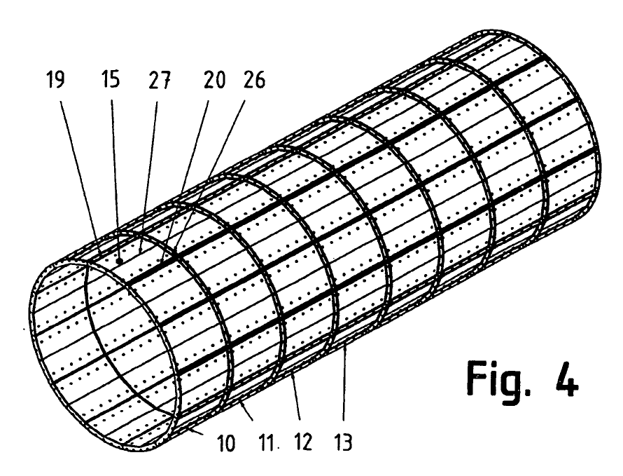

FIG. 4 is a perspective view of a tubular mill shell which is screwed together from eight partial lengths, in which all the partial lengths are screwed together from the segments in FIG. 3,

FIG. 5 shows a detail of a longitudinal section through a rotatably mounted tubular mill shell whose partial lengths are also clamped to one another by means of additional tensioning or clamping elements such as cables,

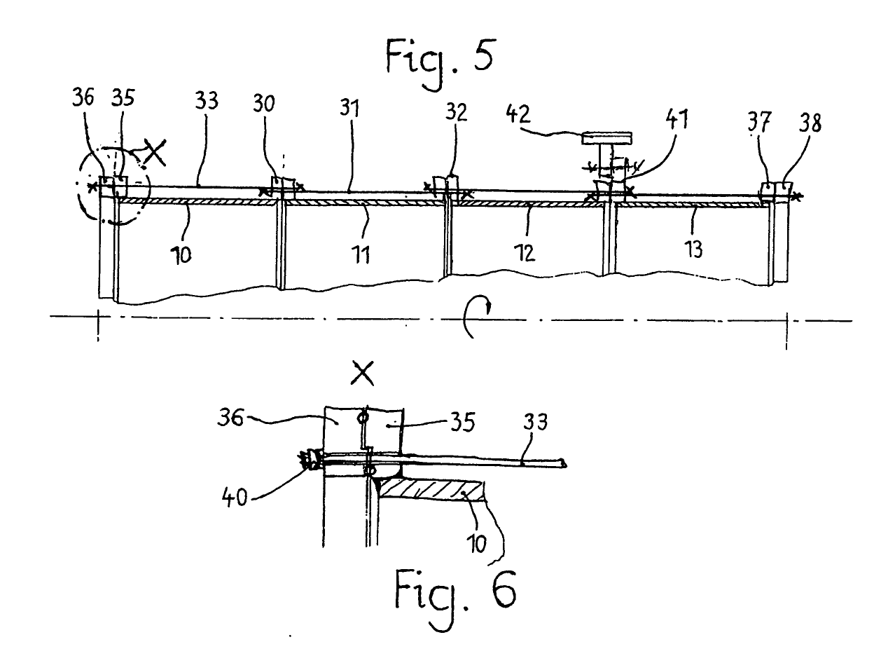

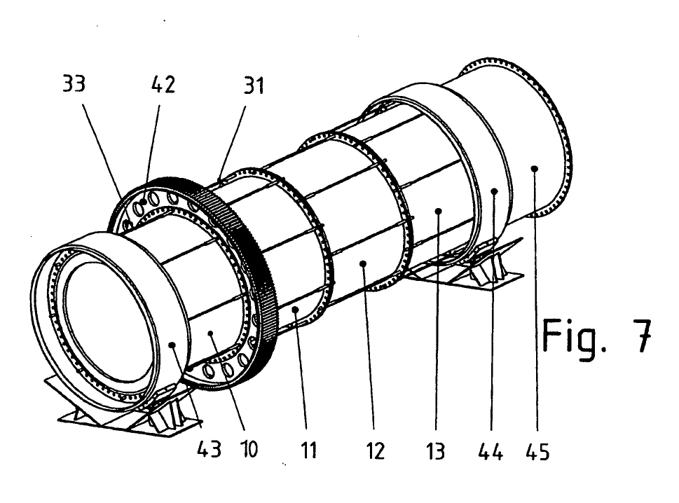

FIG. 6 shows an enlarged, highlighted view of the detail X of FIG. 5, and

FIG. 7 is a perspective view of a mill tube whose partial lengths are clamped in the manner of FIG. 5 by means of cables which are distributed around the circumference of the mill tube shell.

The mill tube of the tubular mill according to the invention is, according to the exemplary embodiment in FIG. 4, composed of eight partial lengths 10, 11, 12, 13 etc., which are screwed together and can each have, for example, a width of approximately 3000 mm. The input end for material to be milled is located at one end of the screwed-together mill tube, and the discharge end for the milled material is located at the other end.

All the partial lengths 10 to 13 etc. are screwed together from prefabricated, thin-walled, sheet-metal segments distributed around the circumference in FIG. 3. The prefabricated segment 15 in FIG. 3 is manufactured by starting from the flat, rectangular sheet-metal segment 15 in FIG. 1, in which at first the four corners 15a, 15b etc. are cut out. Furthermore, the segments 15 which are initially flat can be provided with throughbores 16 for later attachment of armoring elements to the inner wall of the screwed-together tubular mill shell, and with flange bores 21 at the edge of the segment.

By folding the edges, positioned opposite one another, of the segments 15 at the lines 17 and 18 which are indicated by dashes, rigid flanges 19 and 20 are integrally formed onto the abutting sides of adjacent segments by bending over the sheet metal through not quite 90°, said flanges 19 and 20 having been previously provided with the flange bores 21, as is apparent from FIGS. 2 and 3. Flanges 25, 26 which have also been previously provided with flange bores 24 can also be integrally formed onto the other two sides, positioned opposite one another, of the segments 15 by folding through approximately 90° along the lines 22 and 23 in FIG. 1 which are indicated by dashes. In order to increase the rigidity, all four flanges of a segment are also welded to the abutting flange corners.

In addition, from FIG. 3 it is apparent that the segments 15 have, in the central region, at least one reinforcement bend 27 which runs in the longitudinal direction of the mill pipe and by means of which the segments 15 are given a gable-roof-shaped configuration. According to FIG. 2, the bend 27, formed by a bending process, in the segment 15 can have been manufactured before the flanges 25 and 26 have been integrally formed on, which flanges 25 and 26 can also be manufactured by welding on stable flange profiles 25, 26 instead of by a sheet-metal bending process.

At any rate, from FIG. 4 it is clear that the flanges 19 and 20, which come to be positioned in the longitudinal direction of the mill pipe, of each segment 15 are, for example, in the case of the first partial length 10, each screwed to the adjacent flange of the next segment, and the other front-side flanges 26, which when joined together form a flange ring, are screwed together with the corresponding, front-side flanges of the adjacent partial length 11.

In the exemplary embodiment in FIG. 5, comparatively thick-walled rigid flanges 30, etc. are integrally formed on the front sides of the partial lengths 10, 11, 12, etc., not by folding the sheet metal but by welding them on. Apart from by screwing, the flange rings can also be connected to one another in such a way that, in the longitudinal direction of the mill tube, that is to say for example viewed from left to right in FIG. 5, the end flange 30 of the first partial length 10 is clamped in each case to the initial flange 32 of the next but one partial length 12 by means of tensioning or clamping elements 31 which are distributed around the outer circumference of the next partial length 11. In this way, the thin sheet metal shells of the partial lengths are reciprocally prestressed so that they are able to bear the loads and forces which occur during operation of the tubular mill. The clamping elements 31 which are distributed around the circumference of the mill tube shell can be tie rods, but they are also advantageously cables which are arranged parallel to the longitudinal axis of the tube. In contrast to the illustration in FIG. 5, all of the clamping elements 31, 33, in particular cables, lie on the same diameter in all the partial lengths 10 to 13. It has already been mentioned that the partial lengths on the flange rings which abut against one another can also be screwed directly to one another.

All the flange rings are advantageously centered on the surfaces which are clamped one against the other.

In FIG. 5 it is also apparent that a farther flange ring 36 or 38 can be clamped by means of the clamping elements to the initial front side of the first partial length 10 and to the end front side of the last partial length 13, in each case to the first flange ring 35 and last flange ring 37 from the outside. In addition, from FIG. 6 it is apparent that the clamping element 33, in particular the traction cable, is guided through corresponding through openings in the centered flange rings 35, 36 from where it engages from the outside on the first flange ring 36 via an articulated head 40 in order to ensure that only axial forces can be transmitted by the clamping cables 33 which are distributed around the circumference.

FIG. 5 also shows, and this also applies to the mill tube in FIG. 4, that a crown gear 42 for the rotary drive of the tubular mill can be attached to one of the locations on the flange ring, to the flange ring 41 of the partial length 13 in the exemplary embodiment. If the tubular mill with the mill tube in FIG. 4 or 5 has multiple chambers, then at least one transfer wall for material to be milled is provided in the mill tube, said wall then being expediently attached to one of the locations on the flange ring. If a discharge wall for milled material is necessary at the discharge end for milled material on the tubular mill, which wall has the function of retaining the milling bodies and the oversize granules and of discharging the finely milled finished material, the discharge wall for the milled material is arranged on the location 37, 38 on the flange ring, for example clamped in between the two flange rings 37, 38.

From the perspective view in FIG. 7 it is apparent that all the clamping elements which are distributed around the circumference of the mill tube shell are positioned on the same diameter. In this exemplary embodiment, the drive crown gear 42 is attached between the flange rings of the partial lengths 10 and 11. The two running rings or sliding rings 43 and 44 for mounting the sliding shoes of the mill tube are also indicated. A cylindrical drying chamber 45 without milling bodies is also fitted on the partial length 13, in which drying chamber 45 the moist material for milling which enters the tubular mill from the right is dried by means of hot gas. The dried and milled material then leaves at the left-hand end of the tubular mill in FIG. 7.

In the tubular mill according to the invention, further stiffening of the thin-walled mill tube can also be carried out by clamping armoring to the inner wall of the mill tube, which armoring interacts with the mill bodies such as, for example, steel balls of the tubular mill.

At any rate, the tubular mill which is constructed according to the invention is very lightweight and easy and inexpensive to manufacture in comparison.

1-10. (canceled)

11. A tubular mill having a mill tube which is mounted so as to be rotatable about a longitudinal axis, the mill tube comprising:
a shell composed of a plurality of partial lengths, the partial lengths being screwed together from segments which are distributed around the circumference and are made of thin-walled sheet-metal material;
rigid flanges integrally formed onto abutting sides of adjacent segments, and the flanges, which come to be positioned in the longitudinal direction of the mill tube, of adjacent segments are screwed to one another;
rigid flanges also integrally formed onto the two other sides, positioned opposite one another, of the segments, and the flanges, each joined together to form a flange ring, of adjacent partial lengths are clamped to one another by means of clamping elements.

12. The tubular mill as claimed in claim 11, wherein the side flanges of the segments are produced by folding edges of the segments.

13. The tubular mill as claimed in claim 11, wherein each of the segments has at least one reinforcing bend which runs in the longitudinal direction of the mill tube and which give the segments a gable-roof-shaped configuration.

14. The tubular mill as claimed in claim 11, wherein the segments are provided with throughbores for attaching armoring elements to an inner wall of the screwed-together tubular mill shell.

15. The tubular mill as claimed in claim 11, wherein the flange rings of adjacent partial lengths are attached to one another in such a way that, viewed in the longitudinal direction of the mill tube, the end flange of one partial length is attached in each case to an end flange of the next abutting partial length by means of elements which are distributed around the outer circumference of the next partial length.

16. The tubular mill as claimed in claim 15, wherein the elements which are distributed around the circumference of the mill tube shell are tensioning rods.

17. The tubular mill as claimed in claim 15, wherein the elements which are distributed around the circumference of the mill tube shell are cables.

18. The tubular mill as claimed in claim 15, wherein the elements which are distributed around the circumference of the mill tube shell are arranged parallel to the longitudinal axis of the tube.

19. The tubular mill as claimed in claim 15, wherein the elements which are distributed around the circumference of the mill tube shell are arranged diagonal to the longitudinal axis of the tube.

20. The tube mill as claimed in claim 15, wherein in each case two flange rings are attached to a starting front side of a first partial length and to an end side of a last partial length.

21. The tubular mill as claimed in claim 11, wherein a crown gear for a rotary drive of the tubular mill is attached to the flange ring.

22. The tubular mill as claimed in claim 11, wherein, in the mill tube, a milled material discharge wall of a multi-chamber tubular mill is attached to the flange ring.

23. The tubular mill as claimed in claim 11, wherein, in the mill tube, a milled material discharge wall is attached to a discharge end for the milled material.

24. A tubular mill having a mill tube which is mounted so as to be rotatable about a longitudinal axis, the mill tube comprising:
a shell composed of a plurality of ring shaped partial lengths, with the partial lengths abutting one another in the longitudinal direction,
the partial lengths being formed from a plurality of generally rectangular shaped segments which are arranged around a circumference of each partial length, the segments being made of thin-walled sheet-metal material;
rigid flanges integrally formed onto each side of each segment, the flanges extending in the longitudinal direction of the mill tube being secured to the abutting flanges of adjacent segments;
the rigid flanges extending along non-longitudinal sides being joined together to form a flange ring, with the flange rings of each partial length being secured to the abutting flange rings of adjacent partial lengths.

25. A tubular mill as claimed in claim 24, wherein the flanges extending in the longitudinal direction of the mill tube are secured to the abutting flanges of adjacent segments by screws.

26. A tubular mill as claimed in claim 24, wherein the flange rings are secured to abutting flange rings by clamping elements.

27. The tubular mill as claimed in claim 24, wherein the flanges of the segments are produced by folding edges of the segments.

28. The tubular mill as claimed in claim 24, wherein the flanges of the segments are produced by welding flanges onto edges of the segments.

29. The tubular mill as claimed in claim 24, wherein each of the segments has at least one reinforcing bend which runs in the longitudinal direction of the mill tube and which give the segments a gable-roof-shaped configuration.

30. A tubular mill having a mill tube which is mounted so as to be rotatable about a longitudinal axis, the mill tube comprising:
a shell composed of a plurality of ring shaped partial lengths, with the partial lengths abutting one another in the longitudinal direction,
the partial lengths each being formed from a plurality of generally rectangular shaped segments which are arranged around a circumference of each partial length, the segments being made of thin-walled sheet-metal material;
rigid flanges integrally formed onto each edge of each segment;
the flanges extending in the longitudinal direction of the mill tube being secured to the abutting flanges of adjacent segments by screws, and the flanges extending along non-longitudinal edges being joined together to form a flange ring, with the flange rings of each partial length being secured to the abutting flange rings of adjacent partial lengths by clamping elements; and
each of the segments having at least one reinforcing bend which runs in the longitudinal direction of the mill tube and which gives each segment a gable-roof-shaped configuration.
